(19) United States
(12) Patent Application Publication
(10) Pub. No.: US 2005/0207833 A1
(43) Pub. Date: Sep. 22, 2005

(54) Connecting device and methods of using the connecting device

(75) Inventor: Patrick T.A. McGrath, Bellevue, WA (US)

Correspondence Address: DARBY & DARBY P.C., P. O. BOX 5257, NEW YORK, NY, 10150-5257, US

(73) Assignee: Redback Industries LLC, Bellevue, WA (US)

(21) Appl. No.: 11/071,669

(22) Filed: Mar. 2, 2005

Related U.S. Application Data
(60) Provisional application No. 60/552,862, filed on Mar. 12, 2004.

(51) Int. Cl. F16B 1/00

(52) U.S. Cl. 403/206

(57) ABSTRACT

A connecting device for secure attachment of an end of a pulling tape or other article includes a body having a first arm and a second arm opposing each other across an opening defined by the body and extending into the body from a distal end of the body; a first cross member extending across the opening from the first arm to the second arm; and a second cross member extending across the opening from the first arm to the second arm and closer to the distal end of the body than the first cross member. The first and second cross members are configured and arranged to provide attachment of the article by wrapping a portion of the article around the first and second cross members.

### CROSS-REFERENCE TO RELATED APPLICATIONS

This Application claims priority under 35 U.S.C. 119(e) of Provisional Patent Application No. 60/552,862, filed on Mar. 12, 2004.

### FIELD

The invention is directed to connecting devices for pulling tape or other articles coupled to the connecting device and methods of using the connecting devices.

### BACKGROUND

In the cable and conduit installation industry, it is common practice to use a pulling tape to tow cable or duct through underground conduits. The pulling tape is generally attached directly to a loop on the pulling grip or directly to a pulling eye. The connection is almost universally made by tying a bowline or overhand knot. The use of the well known bowline or overhand knot connection presents a deficiency because the strength of the knot connection is subject to fracture at a load substantially less than the failure strength of the pulling tape itself. In many cases, the loss in strength can equate to 50% or more of the overall strength of the pulling tape. Strength is lost due to twists and tight bends in the pulling tape at the knot and because the pulling tape tends to shear and cut into itself under tensile stress at the knot. Because costly delays can occur if a knot breaks while a cable is being pulled, it is standard practice to use a pulling tape of high enough break strength to accommodate the inefficiencies of its knot strength.

### BRIEF SUMMARY

One embodiment of the invention is a connecting device for secure attachment of an article. The connecting device includes a body having a first arm and a second arm opposing each other across an opening defined by the body and extending into the body from a distal end of the body; a first cross member extending across the opening from the first arm to the second arm; and a second cross member extending across the opening from the first arm to the second arm and closer to the distal end of the body than the first cross member. The first and second cross members are configured and arranged to provide attachment of the article by wrapping a portion of the article around the first and second cross members. The body can be, for example, a cylindrical body. In at least some embodiments, the article is a pulling tape, fabric sleeve, tubular weave construction, textile interduct, textile conduit, plastic or synthetic sleeve, or the like.

One embodiment is a method of directing an article through an underground conduit. In this method, the article is coupled to the connecting device described above and then the connecting device and coupled article are directed through the underground conduit.

Another embodiment is an apparatus including a body having a first arm and a second arm opposing each other across an opening defined by the body and extending into the body from a distal end of the body; a first cross member extending across the opening from the first arm to the second arm; a second cross member extending across the opening from the first arm to the second arm and closer to the distal end of the body than the first cross member; and an article wrapped around the first and second cross members.

Yet another embodiment is a method of connecting an article. A connecting device is provided having a body, including a first arm and a second arm opposing each other across an opening defined by the body and extending into the body from a distal end of the body, a first cross member extending across the opening from the first arm to the second arm, and a second cross member extending across the opening from the first arm to the second arm and closer to the distal end of the body than the first cross member. A tail end of the article is threaded through the opening and between the body of the connecting device and the first cross member. The tail end is threaded around the second cross member and then between the first and second cross members. The tail end is then threaded through the opening and between the body of the connecting device and the first cross member.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a view of the pulling end of one embodiment of the body of a connecting device;

FIG. 2 is a top plan view of the body of the connecting device of FIG. 1;

FIG. 3 is a view of the clevis end of the body of the connecting device of FIG. 1;

FIG. 4 is a view of the pulling end of the connecting device of FIG. 1;

FIG. 5 is a top plan view of the connecting device of FIG. 1;

FIG. 6 is a view of the clevis end of the connecting device of FIG. 1;

FIG. 7 is a side elevational view of the connecting device of FIG. 1;

FIG. 8 is a top plan view of the cross members of FIG. 5;

FIG. 9 is a top plan view of the clevis pin of FIG. 5;

FIG. 10 is a top plan view of a connecting device shown in operation with a pulling tape attached at the pulling end of the connecting device and an end loop attached at the clevis end of the connecting device;

FIG. 11 is a cross-sectional side view of the connecting device shown in operation with a pulling tape attached at the pulling end of the connecting device and an end loop attached at the clevis end of the connecting device;

FIG. 12 is an enlarged cross-sectional side view illustrating the method of attaching a pulling tape to the connecting device;

FIG. 13 is a partial top plan view of a connecting device body that will accommodate a ¾ inch (about 1.9 cm) wide pulling tape;

FIG. 14 is a partial top plan view of a connecting device body that will accommodate a ⅝ inch (about 1.6 cm) wide pulling tape;

FIG. 15 is a partial top plan view of a connecting device body that will accommodate a ½ inch (about 1.3 cm) wide pulling tape;

FIG. 16 is a top plan view of an embodiment of a connecting device with swivelable ends;

FIG. 17 is a top plan view of another embodiment of a connecting device;

FIG. 18 is a side plan view of the connecting device of FIG. 17;

FIG. 19 is a top plan view of yet another embodiment of a connecting device;

FIG. 20 is a side plan view of the connecting device of FIG. 19;

FIG. 21 is a top plan view of another embodiment of a connecting device; and

FIG. 22 is a top plan view of another embodiment of a connecting device.

### DETAILED DESCRIPTION

This invention provides devices and methods for connecting a pulling tape or other article to a cable pulling grip, pulling eye, mandrel, winch line, or the like used in underground conduits or other applications including, but not limited to, those applications where a pulling tape may be used to tow an object. The invention can be used in underground conduits such as underground cable conduits. For example, underground conduits, such as underground cable conduits, can have diameters of up to 12 inches (about 30 cm) or, in some cases, even more and the connecting device can be used in any of these underground conduits. A connecting device can be particularly useful in underground conduits having a diameter of up to 6 inches (about 15 cm). In some embodiments, the conduit has a diameter that is in the range of 1 to 6 inches (about 2 to 15 cm) or in the range of 1 to 3 inches (about 2 to 8 cm).

In the discussion below, the example of a pulling tape will be used to illustrate the invention; however, it will be recognized that the invention also includes other articles that can be connected to the connecting device and, in particular, those articles that can be connected in the same or similar manner as the pulling tape. Examples of such articles include, but are not limited to, fabric sleeves, tubular weave constructions, textile interduct, textile conduits, plastic or synthetic sleeves, and the like. Preferably, the article is flexible and, more preferably, the article is sufficiently flexible that it can be wrapped or looped around the cross members of the connecting device. Any pulling tape can be used. In at least some embodiments, the pulling tape is a fibrous, flat material that has a width in the range of 0.25 to 1 inch (about 0.6 to 2.6 cm.)

The present invention provides an intermediary connecting device between a pulling tape and pulling grip or pulling eye and a knotless method for attaching a pulling tape to the connecting device so that a greater joint efficiency can be obtained than by the use of conventional bowline and overhand knots. This connecting device utilizes friction and compression of the pulling tape (for example, compression of one portion of the pulling tape against another portion of the pulling tape) to attach the pulling tape to the connecting device.

The connecting device includes two connection point ends. One end can be, for example, a clevis end to attach a pulling grip or pulling eye while the other end provides a fixture for attaching a pulling tape. The method for attaching the pulling tape to the fixture provides a secure connection through friction and compression, eliminating twists and tight bends and significantly reducing shearing and cutting at the pulling tape connection. Examples of such connecting devices are described in U.S. Provisional Patent Application Ser. No. 60/552,862, filed on Mar. 12, 2004, which is incorporated herein by reference.

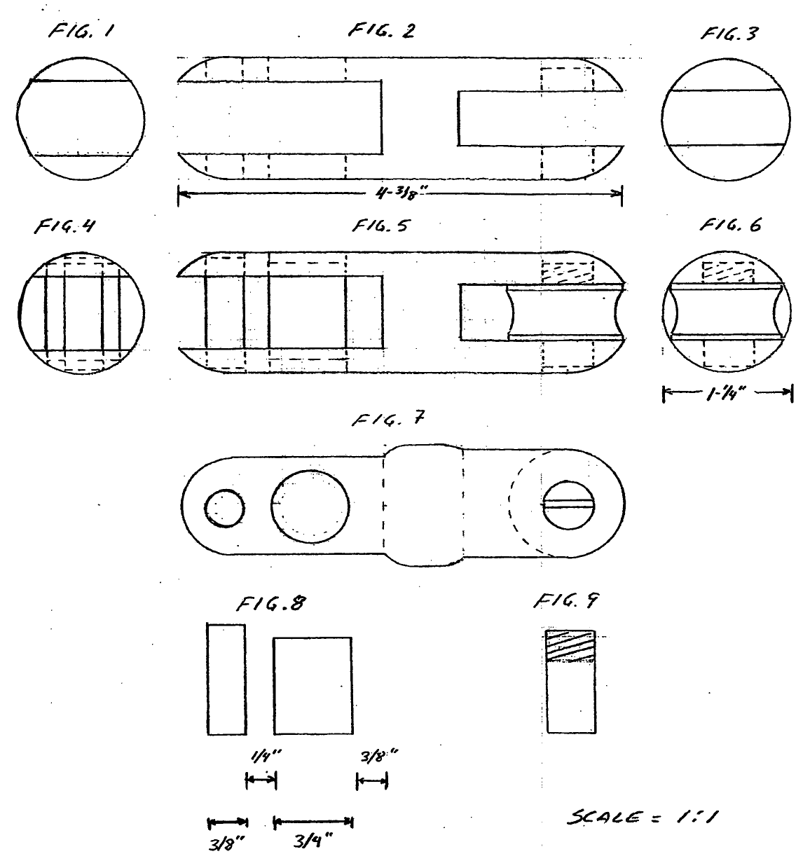

Referring to the drawings, there is shown in FIGS. 1-3 a connecting device 100 having a cylindrical body 102 with ends 110, 120. The ends are optionally tapered and at least one end 110 is bifurcated to form two arms 104, 106 that oppose each other over an opening 108. The other end 120 may also be bifurcated with two arms 116, 118 that oppose each other over an opening 122. The optional tapering can provide a paraboloid-like profile (see FIG. 7) that makes the device less likely to catch on something when being pulled. The body can be made of any suitable material including, for example, aluminum, titanium, stainless steel, and other metals and alloys. A cylindrical body can have an oval or, preferably, circular cross-section.

The body can be formed in a variety of lengths and widths. The length and width of the connecting device may be influenced by factors such as the width of the pulling tape and the size of the conduit through which the connecting device will be pulled. In at least some embodiments, the length of the connecting device is in the range of 3 to 7 inches (about 7 to 18 cm). In at least some embodiments, the width of the connecting device is in the range of 0.5 to 1.5 inches (about 1.2 to 3.8 cm). In one embodiment, the length of the connecting device is 4⅜ inches (about 11 cm) and the width is 1¼ inches (about 3.1 cm).

The width of the opening 108 can be selected in view of the width of the pulling tape that is expected to be used with the particular connecting device. Preferably, the width of the opening 108 is slightly wider than the selected pulling tape. This allows the pulling tape to be conveniently pulled through the connecting device without lifting the edges of the pulling tape if the width of the opening is too small and without substantial lateral movement of the tape if the width of the opening is too large. In at least some embodiment, the width of the opening 108 ranges from about 0.25 to 1.6 inches (about 0.6 to 3.9 cm), for example, 0.5, 0.625, 0.75, or 1 inch (about 1.2, 1.6, 1.9, and 2.6 cm). In some embodiments, the pulling tape (or a portion of the pulling tape proximal to the connecting device of the invention) may be folded lengthwise to provide a folded width that fits the connecting device.

FIGS. 4-6 illustrate connection points formed at ends 110, 120 of the body 102. In at least some embodiments, the connection point ends are longitudinally aligned and centered on the main axis of the body. The first connection point end 110 is the pulling end and the second connection point end 120 can be, for example, a clevis end. In other embodiments, the second connection point end 120 can be a second pulling end, pulling eye, mandrel, duct puller, duct brush, lubricant spreader, and the like.

As shown in FIGS. 4-5 and FIGS. 7-8, the pulling end is comprised of bifurcated arms 104, 106 with cross members 112, 114 running parallel to each other in the form of, for example, tension pins passing through mutually aligned holes in the arms. It will be recognized that more than two cross members (for example, three cross members) can also be used. The cross members 112, 114 are spaced apart and aligned perpendicular to the main axis of the body. It will be appreciated that more than two tension pins could be utilized and that, while for ease of assembly, tension pins are preferably press fitted, however, they could equally be threaded into place. As another alternative, one or both of the cross members can include a pin that extends into the body for securing the pin and a mandrel, having a larger diameter, disposed on the pin and not extending into the body.

The cross members 112, 114 can be cylindrical or can have other shapes. The lateral cross-section of such other shapes can be, for example, oval, square, hexagonal, or any other polygonal shape. Preferably, the shape of the cross members 112, 114 is selected to substantially avoid cutting into the pulling tape at portions of the cross member in contact with the tape or where the tape is compressed against the cross member.

In at least some embodiments, the diameter of the cross member 112 can be at least 0.25 inches (about 0.6 cm), at least 0.5 inches (about 1.2 cm), at least 0.625 inches (about 1.6 cm) or at least 0.75 inches (about 1.9 cm). The diameter of cross member 114 can be, for example, at least 0.25 inches (about 0.6 cm), at least 0.375 inches (about 1 cm), or at least 0.5 inches (about 1.2 cm). In at least some embodiments, the cross member 112 that is farthest from the end 110 of the body 102 has a larger diameter than the other cross member 114. The larger diameter of cross member 114 can assist in anchoring the pulling tape to the connecting device and may reduce cutting and abrasion of the pulling tape. In one embodiment, the diameter of cross member 114 is about one half the diameter of cross member 112. In one embodiment, the cross member 112 has a diameter of 0.75 inches (about 1.9 cm), the cross member 114 has a diameter of 0.375 inches (about 1 cm), the two cross members are separated from each other by about 0.25 inches (about 0.6 cm), and cross member 114 is separated from the body at the end of the opening by about 0.375 inches (about 1 cm).

Cross members 112 and 114 are typically separated by at least the thickness of the pulling tape. Cross member 112 is typically separated from the body 102 at the end of the opening 108 by at least twice, or at least three times, the thickness of the pulling tape.

As shown in FIGS. 5-7 and FIG. 9, a clevis end 120 can be formed by bifurcated arms 116, 118 making a loop closed by a clevis pin 126 passing through mutually aligned holes in the arms with an end threaded into at least one of them. A sheave 124 can run on the clevis pin 126, if desired. Removal of the clevis pin and sheave permits insertion and removal of a pulling grip loop (not shown). Likewise, the sheave can be omitted from the clevis end in order to accommodate, for example, the use of a pulling eye (not shown).

In at least one embodiment as shown in FIG. 10, a pulling tape 126 can be attached at the pulling end and a pulling grip loop 128 attached at the clevis end. It is preferred that the width of the pulling tape closely resemble the width of the gap between the arms of the pulling end so as to maintain center alignment of the pulling tape and therefore balance tensile stress across the width of the pulling tape. Likewise, when attaching a pulling grip loop to the clevis end, the use of a sheave may be preferred in order to maintain center alignment and equal distribution of tensile forces across the width of the pulling tape during a pulling operation.

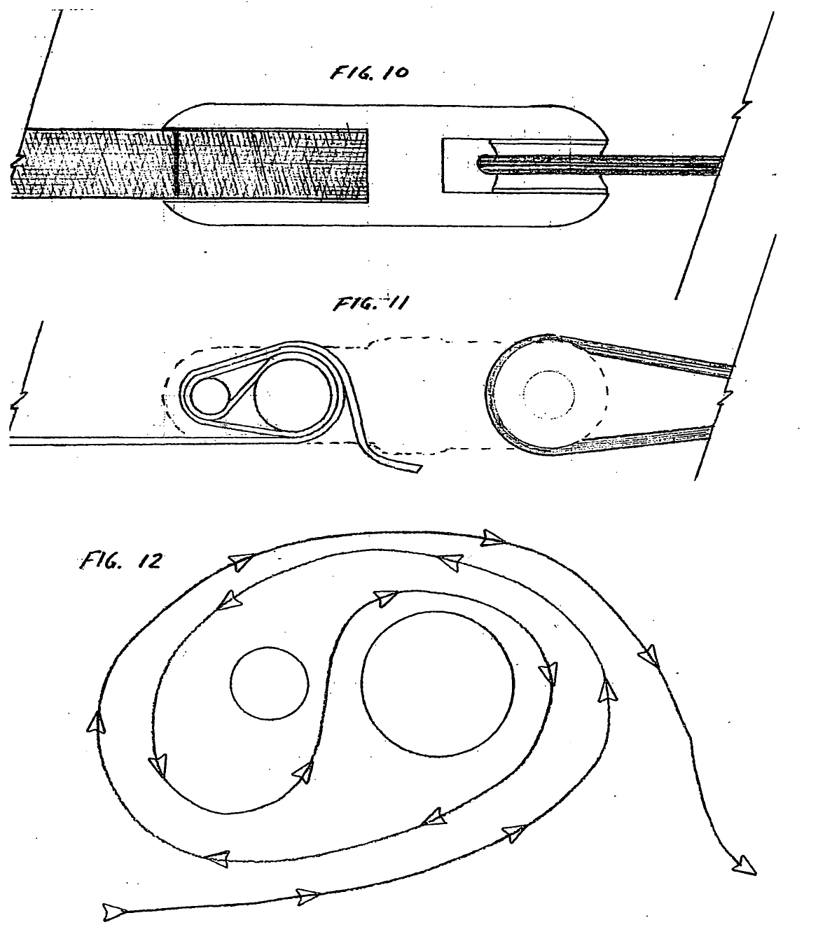

In one example of attachment of the pulling tape to the connecting device, as shown in FIGS. 11-12, the pulling tape 126 can be attached at the pulling end by threading the tail end 132 of the pulling tape first through the opening between the body 102 of the connecting device and the innermost cross member 112, second around the outermost radius of the outermost cross member 114, third between the two cross members 112, 114, and fourth back through the opening between the innermost cross member 112 and the body 102 of the connecting device 102. This fourth step causes the leading end 130 of the pulling tape to compress against a portion 134 of the tail end 132, therefore increasing friction and locking the pulling tape in place. This is unlike most knots where the leading end is compressed by a portion of the tail end or compressed by itself, causing cutting and shearing under tensile stress.

As shown in FIGS. 11-12, to orient the tail end 132 of the pulling tape 126 away from the direction to be pulled, the tail end can be looped around the outermost radius of the outermost cross member 114 and then tucked back through the opening between the innermost cross member 112 and the connecting device body 102. Optionally, this tail end can then be fastened (for example, taped with adhesive tape) to an outer surface 140 of the body 102. Appropriate care should be taken to ensure the pulling tape lies flat and centered on the cross members and does not twist, fold or bunch up at the edges as it is threaded onto the connecting device. As one alternative to the arrangement illustrated in FIGS. 11-12, the tail end 132 is not tucked back through the opening between the inner most cross member 112 and the connecting device body 102. Instead, the tail end 132 is fastened (for example, taped with adhesive tape) to an outer surface 142 of the body 102.

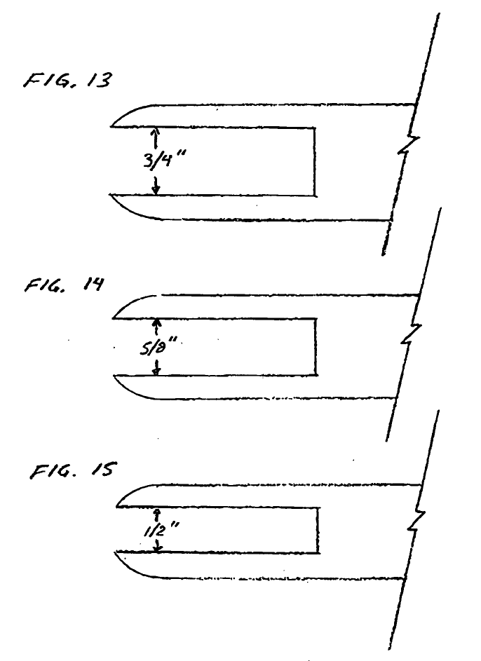

FIGS. 13-15 illustrate size variations of the invention to accommodate pulling tapes of different widths. Even though a larger opening in the pulling end can accommodate a pulling tape of smaller width, it is preferred that the width of the pulling tape closely resemble the width of the gap between the arms of the pulling end so as to maintain center alignment of the pulling tape.

It is to be understood that what has been described are preferred embodiments of the invention and that it is possible to make variations to these embodiments while staying within the broad scope of the invention. Some of these variations have been discussed while others will be readily apparent to those skilled in the art to which the invention relates. For example, while reference has been made to the use of a clevis on one end, a variety of other attachments could be equally used. In addition, FIG. 7 shows the use of tension pins to form the cross members at the pulling end, even though their function is not limited to tension pins.

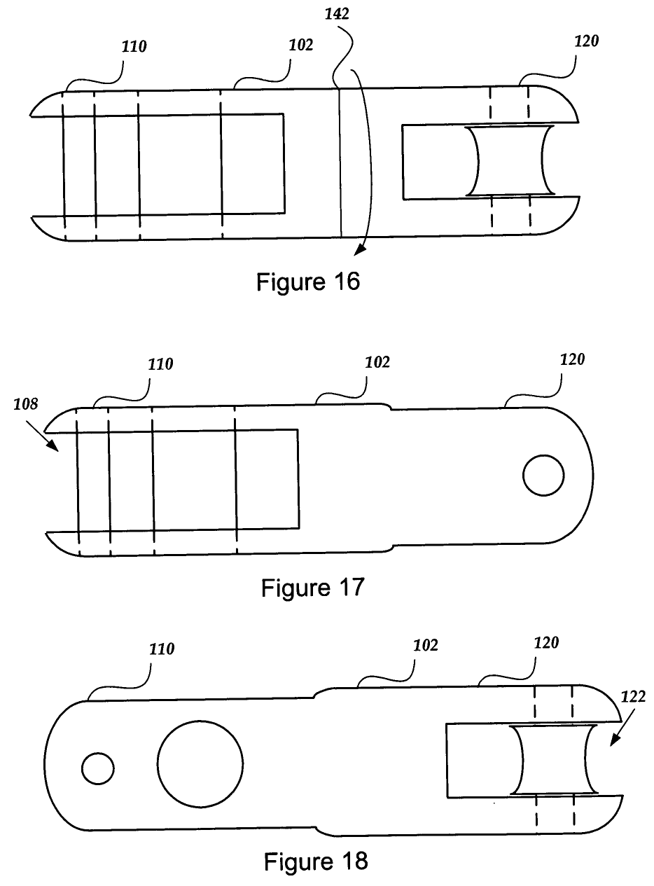

Furthermore, variations can be made to incorporate a swivel or breakaway device into the connecting device. For example, the connecting device can be made so that one end 120 is swivelable relative to the other end 110 about a swivel line 142 as illustrated, for example, in FIG. 16.

In yet another embodiment, the opening 112 in end 120 can be oriented 90° around the body relative to the opening 108 in end 110 as illustrated, for example, in FIGS. 17 and 18. Any other angular orientation (e.g., angles other than 0° or 90°) between openings 108 and 112 can be used.

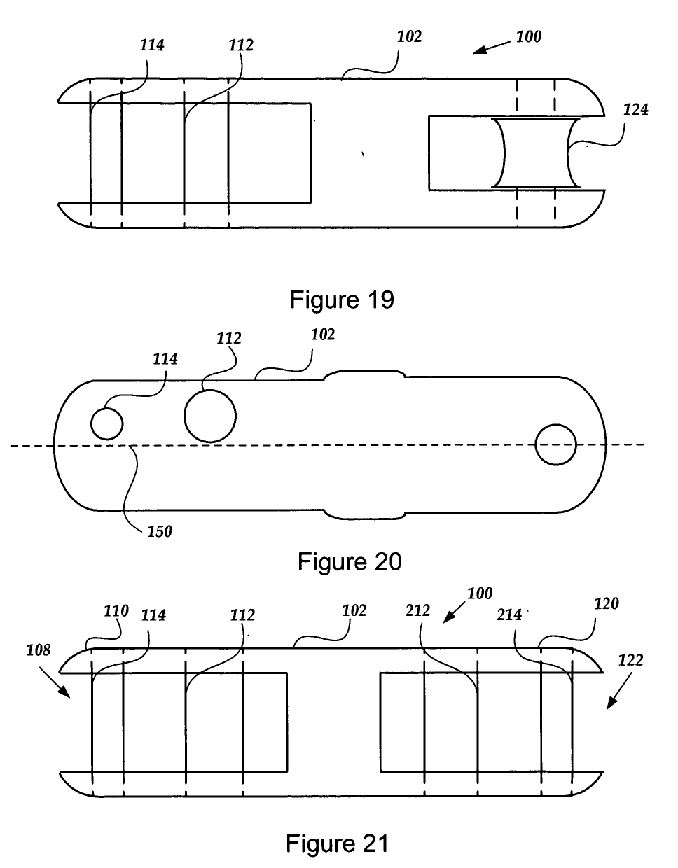

In another embodiment, the cross members 112, 114 are not centered in the openings, as illustrated, for example, in FIGS. 19 and 20, but are offset from the center. This offset can be selected, if desired, so that the leading end of the pulling tape, which exits the connecting device, is positioned nearer, or even at, the central longitudinal axis 150 of the body 102. By positioning the pulling tape in this manner there is less force being applied perpendicular to the central axis 150 as the pulling tape is pulled. This may make the pulling of tape through tight conduits even easier.

In a further embodiment, pulling ends are provided at both end 110 and end 120 so that pulling tape can be coupled to the connecting device at both ends as illustrated, for example, in FIG. 21. For example, end 120 can be bifurcated into two arms 116, 118 and cross members 212, 214 can extend across opening 122 similar to cross members 112, 114. A second pulling tape can then be attached to cross members 212, 214 in the same manner as the first pulling tape is attached to cross members 112, 114. In addition, as described above, the two ends can be swivelable or the openings can be offset (for example, by 90°), or one or both sets of cross members can be offset from the central axis. Additionally or alternatively, the two pulling tapes can be attached so that they both exit the connecting device from the same side (e.g., both from the top or the bottom) or one tape can exit from one side (e.g., from the top) and the other tape from the opposite side (e.g., from the bottom).

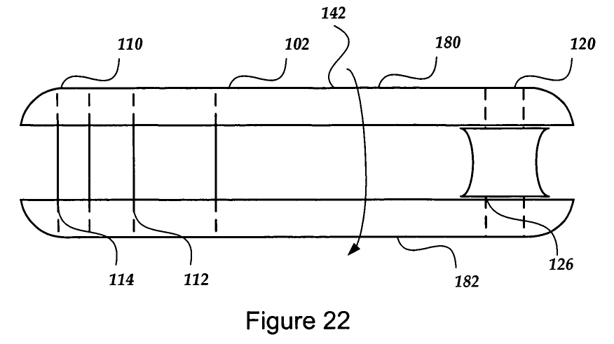

In yet another embodiment, as illustrated in FIG. 22, the body 102 is not unitary, but instead includes two separate pieces 180, 182 that are connected only by the cross members 212, 214 and the clevis pin 126. It will be recognized that items other than the clevis pin can be used including, for example, one, two, or more additional cross members, a pulling eye, and the like.

Use of the connecting devices describe herein may provide increased joint efficiency when compared to other methods of pulling tape attachment, such as overhand or bowline knots. Joint efficiency can be determined by measurement of the force required to break the pulling tape with and without the attachment method (e.g., a knot or the connecting devices described herein). Joint efficiency can be described as a percentage of the breaking force with the attachment method as compared to the linear breaking force (e.g., the force to break an unattached pulling tape). Knots typically have a joint efficiency of 75% or less and, in at least some instances, the joint efficiency can be 50% or less. In at least some embodiments, the joint efficiency of the connecting devices described herein can be at least 90% or at least 95% and, in some embodiments, the joint efficiency can be 100%.

The above specification and examples provide a description of the manufacture and use of the composition of the invention. Since many embodiments of the invention can be made without departing from the spirit and scope of the invention, the invention also resides in the claims hereinafter appended.

1. A connecting device for secure attachment of an end of an article, comprising:
a cylindrical body comprising a first arm and a second arm opposing each other across an opening defined by the body and extending into the body from a distal end of the body;
a first cross member extending across the opening from the first arm to the second arm; and
a second cross member extending across the opening from the first arm to the second arm and closer to the distal end of the body than the first cross member;
wherein the first and second cross members are configured and arranged to provide attachment of the article by wrapping a portion of the article around the first and second cross members.

2. The connecting device of claim 1, wherein first and second cross members are cylindrical.

3. The connecting device of claim 1, wherein the first cross member has a larger diameter than the second cross member.

4. The connecting device of claim 1, wherein the first and second cross members are offset from the central longitudinal axis of the body.

5. The connecting device of claim 4, wherein the first and second cross members are offset from the central longitudinal axis of the body so that a leading end of the article exits the connecting device substantially along the central longitudinal axis.

6. The connecting device of claim 1, wherein the body further comprises a third arm and a fourth arm opposing each other across a second opening defined by the body and extending into the body from a proximal end of the body.

7. The connecting device of claim 6, wherein the third and fourth arm are swivelable relative to the first and second arms.

8. The connecting device of claim 6, further comprising a clevis pin extending across the second opening between the third and fourth arms.

9. The connecting device of claim 8, further comprising a sheave disposed on the clevis pin.

10. The connecting device of claim 6, wherein the opening and second opening are offset from each other around the body of the connecting device.

11. The connecting device of claim 6, further comprising a third cross member extending across the second opening from the third arm to the fourth arm and a fourth cross member extending across the second opening from the third arm to the fourth arm and closer to the proximal end of the body than the third cross member,
wherein the third and fourth cross members are configured and arranged to provide attachment of a second article by wrapping a portion of the second article around the third and fourth cross members.

12. The connecting device of claim 1, wherein the body is a unitary body.

13. An apparatus comprising the connecting device of claim 1 and an article, a portion of which is wrapped around the first and second cross members of the connecting device.

14. A method of directing an article through an underground conduit, the method comprising:
coupling the article to a connecting device, the connecting device comprising i) a body comprising a first arm and a second arm opposing each other across an opening defined by the body and extending into the body from a distal end of the body, ii) a first cross member extending across the opening from the first arm to the second arm, and iii) a second cross member extending across the opening from the first arm to the second arm and closer to the distal end of the body than the first cross member, wherein the first and second cross members are configured and arranged to provide attachment of the article by wrapping a portion of the article around the first and second cross members; and
directing the connecting device with the coupled article through the underground conduit.

15. The method of claim 14, wherein the article is a pulling tape.

16. The method of claim 14, further comprising coupling a pulling arrangement to the connecting member to pull the connecting device and coupled article through the underground conduit.

17. The method of claim 14, wherein the underground conduit is a cable conduit.

18. A method of connecting an article, the method comprising:
(i) providing a connecting device having a body, comprising a first arm and a second arm opposing each other across an opening defined by the body and extending into the body from a distal end of the body, a first cross member extending across the opening from the first arm to the second arm, and a second cross member extending across the opening from the first arm to the second arm and closer to the distal end of the body than the first cross member;
(ii) threading a tail end of the article through the opening and between the body of the connecting device and the first cross member;
(iii) threading the tail end around the second cross member;
(iv) threading the tail end between the first and second cross members; and
(v) threading the tail end through the opening and between the body of the connecting device and the first cross member.

19. The method of claim 18, further comprising (vi) threading the tail end around the second cross member and between the body of the connecting device and the first cross member.

20. The method of claim 19, further comprising taping the tail end to the body of the connecting device.
